(19) United States
(12) Patent Application Publication
(10) Pub. No.: US 2016/0263724 A1
(43) Pub. Date: Sep. 15, 2016

(54) GRINDING WHEEL AND GRINDING MACHINE

(71) Applicant: JTEKT CORPORATION, Osaka-shi (JP)

(72) Inventors: Shinji SOMA, Kashiwara-shi (JP); Naoto ONO, Anjo-shi (JP); Satoru KATO, Nagakute-shi (JP)

(73) Assignee: JTEKT CORPORATION, Osaka-shi (JP)

(21) Appl. No.: 15/062,569

(22) Filed: Mar. 7, 2016

(30) Foreign Application Priority Data
Mar. 10, 2015 (JP) 2015-047561

(51) Int. Cl. B24B 53/04; B23K 26/361; B24D 3/34

(52) U.S. Cl. CPC B24B 53/04; B24D 3/342; B23K 26/361

(57) ABSTRACT

A grinding wheel includes a plurality of abrasive grains and a binder holding the abrasive grains together. The binder contains an additive that has a higher extinction coefficient than the abrasive grains at a wavelength in a predetermined frequency band. The binder is processed with laser light of a wavelength in the predetermined frequency band.

### INCORPORATION BY REFERENCE

The disclosure of Japanese Patent Application No. 2015-047561 filed on Mar. 10, 2015 including the specification, drawings and abstract, is incorporated herein by reference in its entirety.

### BACKGROUND OF THE INVENTION

1. Field of the Invention

The present invention relates to grinding wheels including abrasive grains and a binder which can be shaped with laser light, and grinding machines including the grinding wheel.

2. Description of the Related Art

Japanese Patent No. 4186658 and Japanese Patent Application Publication No. 2005-52942 (JP 2005-52942 A) describe truing (shaping) and dressing (sharpening) of the surface of a grinding wheel with laser light. Japanese Patent No. 4186658 describes that abrasive grains are made of a material requiring laser light of a higher energy density than a binder. In Japanese Patent No. 4186658, truing is performed under a first set condition that provides such an energy density that can remove both the abrasive grains and the binder, and dressing is performed under a second set condition that provides such an energy density that can mainly remove the binder.

However, some binders are not processed with laser light that can process the abrasive grains. Truing and dressing as described in Japanese Patent No. 4186658 cannot be performed in the case of using such binders.

### SUMMARY OF THE INVENTION

It is one object of the present invention to provide a grinding machine that can true or dress a grinding wheel with laser light even if the energy density of laser light which can process a main component of a binder is higher than that of laser light which can process abrasive grains.

According to one aspect of the present invention, a grinding wheel includes: a plurality of abrasive grains; and a binder mainly containing a bond material and holding the abrasive grains together. The binder contains an additive that has a higher extinction coefficient than the abrasive grains at a wavelength in a predetermined frequency band.

According to another aspect of the present invention, a grinding machine includes: a wheel spindle stock on which the grinding wheel of the above aspect is mounted; and a wheel truing device having a laser oscillator. The binder is processed by emitting laser light of the wavelength in the predetermined frequency band from the laser oscillator to the grinding wheel.

In the grinding wheel or the grinding machine of the above aspect, the binder contains the additive that has a higher extinction coefficient than the abrasive grains at the wavelength in the predetermined frequency band. The binder therefore reliably absorbs laser light more than the abrasive grains do. As a result, the binder is reliably processed with the laser light. The grinding wheel is therefore reliably trued or dressed with the laser light.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a plan view of a grinding machine of an embodiment of the present invention;

FIG. 2 is an enlarged view of the surface side of a grinding wheel;

FIG. 3 is a graph showing the relationship between the energy density of laser light and the processing depth of a binder A1 containing an additive, a binder A2 containing no additive, and abrasive grains B;

FIG. 4 is a diagram of the grinding wheel that is trued with laser light; and

FIG. 5 is a diagram of the grinding wheel that is dressed with laser light.

### DETAILED DESCRIPTION OF EMBODIMENTS

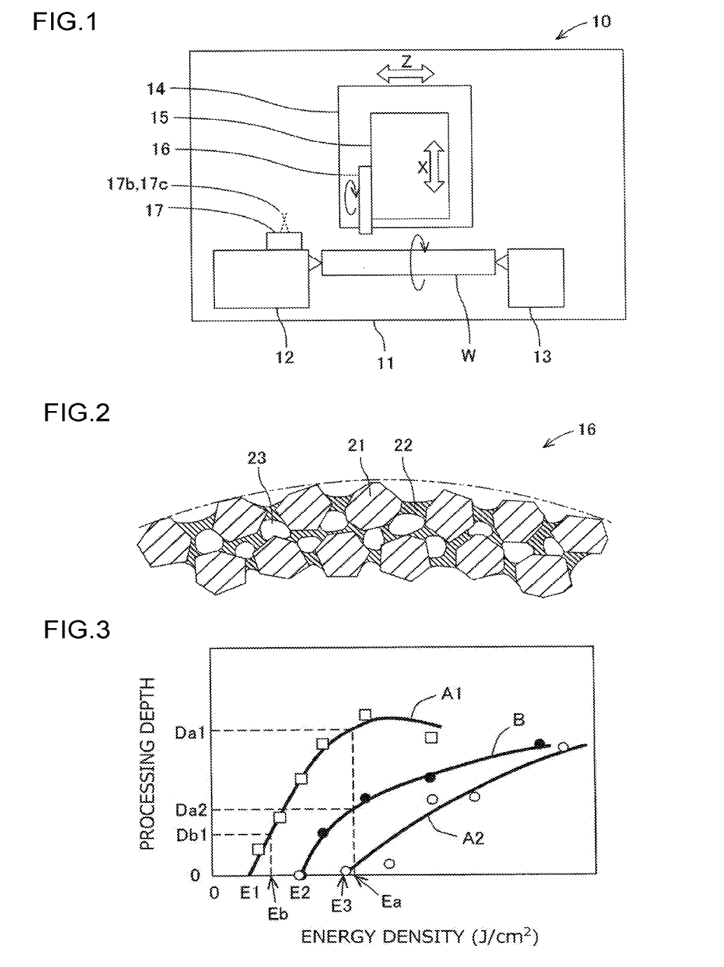

The configuration of a grinding machine 10 will be described with reference to FIG. 1. As an example, the grinding machine 10 is an external cylindrical grinding machine that grinds a cylindrical workpiece W by a grinding wheel 16 while rotating the workpiece W. The grinding machine 10 includes a bed 11, a headstock 12, a tailstock 13, a traverse table 14, a wheel spindle stock 15, the grinding wheel 16, and a wheel truing device 17.

The headstock 12 is fixed to the bed 11, and includes a spindle (not shown) that rotates about an axis parallel to the Z-axis direction, and a spindle rotation motor (not shown) for rotating the spindle. The headstock 12 supports one end of the workpiece W and rotationally drives the workpiece W. The tailstock 13 is disposed on the bed 11 so as to face the headstock 12, and supports the other end of the workpiece W.

The traverse table 14 is disposed on the bed 11 so as to be separated from the headstock 12 and the tailstock 13 in the X-axis direction and is movable in the Z-axis direction on the bed 11. The wheel spindle stock 15 is disposed on the traverse table 14 and is movable in the X-axis direction on the traverse table 14. The grinding wheel 16 is mounted on the wheel spindle stock 15 and is supported so as to be rotatable about an axis parallel to the Z-axis direction. The grinding wheel 16 is rotationally driven by a grinding wheel spindle rotation motor (not shown) provided in the wheel spindle stock 15.

The wheel truing device 17 trues and dresses the grinding wheel 16. Truing is the process of forming a desired shape on the surface of the grinding wheel 16. Dressing is the process of sharpening the grinding wheel 16. The wheel truing device 17 has a laser oscillator (not shown) and performs truing and dressing with laser light that is emitted from the laser oscillator.

The configuration of the grinding wheel 16 will be described in detail with reference to FIG. 2. The grinding wheel 16 includes a plurality of abrasive grains 21, a binder 22 that holds the abrasive grains 21 together, and pores 23 formed between the binder 22 and the abrasive grains 21. For example, the abrasive grains 21 are cubic boron nitride (CBN) grains or diamond grains.

The binder 22 mainly contains vitrified bond as a vitreous bond material, metal bond, resin bond, etc. In the present embodiment, vitrified bond is used as the binder 22. In this case, as shown in FIG. 2, the binder 22 holds the abrasive grains 21 together like a bridge. Moreover, in the case of using vitrified bond as the binder 22, it is easy to adjust the pores 23 that serve as chip pockets.

The binder 22 contains an additive in addition to the main component. The additive has a higher extinction coefficient than the abrasive grains 21 and the main component of the binder 22 at a wavelength in a predetermined frequency band of laser light. For example, the additive is titanium carbide (TiC) in the present embodiment.

The extinction coefficient κ is an imaginary part of a complex refractive index N given by Formula (1). The extinction coefficient x is an optical constant representing absorption of laser light. In Formula (1), a real part n of the complex refractive index N represents a refractive index.

N=n+iκ (1)

Table 1 shows the refractive indices n and the extinction coefficients κ of CBN as the abrasive grains 21 of the grinding wheel 16, the vitreous bond material as the main component of the binder 22, and TiC as the additive of the binder 22. Table 1 shows the refractive indices n and the extinction coefficients κ for three waveforms λ0 of laser light.

TABLE 1
Complex Refractive Indices N of Materials

| | CBN | | Vitreous Bond Material | | TiC | |
|---|---|---|---|---|---|---|
| λ | n | κ | n | κ | n | κ |
| 1.05 μm | 2.105 | <2.11 × 10⁻⁸ | 1.506 | <3.65 × 10⁻¹⁰ | 3.72 | 3.40 |
| 0.78 μm | 2.108 | <2.14 × 10⁻⁸ | 1.511 | <3.65 × 10⁻¹⁰ | 3.42 | 2.98 |
| 0.35 μm | 2.111 | <2.11 × 10⁻⁸ | 1.539 | 2.82 × 10⁻⁷ | 2.57 | 2.34 |

According to Table 1, TiC as the additive has a significantly higher extinction coefficient κ than CBN and the vitreous bond material at any of the three wavelengths λ. At the wavelengths λ, of 1.05 μm and 0.78 μm, the extinction coefficient κ of the vitreous bond material is lower than that of CBN by about two orders of magnitude. However, at the wavelength λ, of 0.35 μm, the extinction coefficient x of the vitreous bond material is higher than that of CBN.

In the present embodiment, the wheel truing device 17 trues and dresses the grinding wheel 16 with laser light. In order for an object to be processed with laser light, laser light need be absorbed by the object. The relationship between the absorbance A_{λ} and the extinction coefficient κ of the above materials will be described. The absorbance A_{λ} represents the degree to which laser light is absorbed by the object.

The absorbance A_{λ} is a dimensionless quantity representing the degree to which the intensity of laser light decreases as the laser light passes through an object. The absorbance A_{λ} is given by Formula (2). Namely, the absorbance A_{λ} is the common logarithm of the ratio of the intensity I of transmitted light to the intensity I₀ of incident light (transmittance). A minus sign is added in order for the absorbance A_{λ} to have a positive value when the object absorbs laser light.

A_{λ}=−log₁₀(I/I₀) (2)

According to the Beer-Lambert law, the absorbance A_{λ} is given by Formula (3). In the case where the intensity I of transmitted light is the intensity of laser light that has traveled along a path of a length L in the object, the absorbance A_{λ} is proportional to the length L of the light path in the object and the concentration C of the object. The absorption coefficient α in Formula (3) is given by Formula (4). In Formula (4), κ represents the extinction coefficient and λ represents the wavelength of laser light.

A_{λ}=αLC (3)

α=4πκ/λ (4)

Formulae (2), (3), (4) show that the larger the extinction coefficient κ of the object is, the higher the absorbance A_{λ} is. Moreover, the higher the concentration C of the object is, the higher the absorbance A_{λ} is. As described below, in order to true and dress the grinding wheel 16, the absorbance A_{λ} of the binder 22 should be higher than that of the abrasive grains 21 by one or more orders of magnitude.

For example, in the case where the wavelength λ, of laser light is 1.05 μm and the Rayleigh length thereof is 10 μm, the absorbance A_{λ(CBN)} of the abrasive grains 21, namely CBN, is given by Formula (5). Formula (6) needs to be satisfied in order for the absorbance A_{λ(ADD)} of TiC as the additive of the binder 22 to be higher than the absorbance A_{λ(CBN)} of the abrasive grains 21 by one or more orders of magnitude. According to Formula (6), the concentration C of TiC as the additive of the binder 22 needs to be in the range given by Formula (7).

$$\begin{matrix}\begin{matrix}{A}_{λ ( CRN )} = {α}_{CRN} L \\ = ( 4 πκ / λ ) * ( 10 * {10}^{- 6} ) \\ = 2.5 * {10}^{- 6}\end{matrix} & ( 5 ) \\ {A}_{λ ( ADD )} = {α}_{ADD} {LC}_{ADD} > 2.5 * {10}^{5} & ( 6 ) \\ {C}_{ADD} > 6.2 * {10}^{8} & ( 7 )\end{matrix}$$

The relationship between the energy density of laser light and the processing depth of the abrasive grains 21 and the binder 22 will be described with reference to FIG. 3. In this example, the abrasive grains 21 are CBN grains. The binder 22 mainly contains the vitreous bond material and contains TiC as the additive at the concentration C_{ADD} in the range given by Formula (7). A binder 22, which is a vitreous bond material containing no TiC as an additive, is used as a comparative example.

As shown in Table 1, TiC has a significantly higher extinction coefficient κ than CBN and the vitreous bond material. Accordingly, the more the binder 22 contains TiC, the higher the absorbance A_{λ} of the binder 22 is. That is, the binder 22 containing TiC as the additive has higher absorbance A_{λ} than the abrasive grains 21, and the abrasive grains 21 have higher absorbance A_{λ} than the binder 22 containing no TiC as the additive.

In this case, the relationship between the energy density and the processing depth of the abrasive grains 21, the binder 22 containing TiC as the additive, and the binder 22 containing no TiC as the additive is as shown in FIG. 3. In FIG. 3, A1 represents the binder 22 containing TiC as the additive, A2 represents the binder 22 made of the vitreous bond material containing no TiC as the additive, and B represents the abrasive grains 21 made of CBN.

CBN is processed when the energy density is E2 or higher. E2 is therefore an energy density threshold for processing the abrasive grains 21, namely the lowest energy density of laser light that can process CBN (hereinafter referred to as the “abrasive grain processing threshold E2”). The higher the energy density is than E2, the greater the processing depth of CBN is. For example, when the energy density is Ea, the processing depth of CBN is Da2.

The vitreous bond material containing TiC as the additive is processed when the energy density is E1 or higher. E1 is therefore an energy density threshold for processing the binder 22 containing TiC as the additive, namely the lowest energy density of laser light that can process the vitreous bond material containing TiC as the additive (hereinafter referred to as the “binder processing threshold E1”). The binder processing threshold E1 is lower than the abrasive grain processing threshold E2. That is, the binder 22 containing TiC as the additive can be processed at a lower energy density than the abrasive grains 21. For example, when the energy density is Eb that is higher than the binder processing threshold E1 and lower than the abrasive grain processing threshold E2, the binder 22 containing TiC as the additive is processed, but the abrasive grains 21 are not processed.

The higher the energy density is than E1, the greater the processing depth of the binder 22 containing TiC as the additive is. At higher energy densities, the processing depth of the binder 22 containing TiC as the additive is greater than that of the abrasive grains 21. For example, when the energy density is Ea, the processing depth Da1 of the binder 22 containing TiC as the additive is greater than the processing depth Da2 of the abrasive grains 21.

The vitreous bond material containing no TiC as the additive is processed when the energy density is E3 or higher. E3 is therefore an energy density threshold for processing the binder 22 containing no TiC as the additive, namely the lowest energy density of laser light that can process the vitreous bond material containing no TiC as the additive (hereinafter referred to as the “processing threshold E3”). The processing threshold E3 is higher than the abrasive grain processing threshold E2. The higher the energy density is than E3, the greater the processing depth of the binder 22 containing no TiC as the additive is. The energy density required for processing to about the same processing depth is higher for the binder 22 containing no TiC as the additive than for the abrasive grains 21.

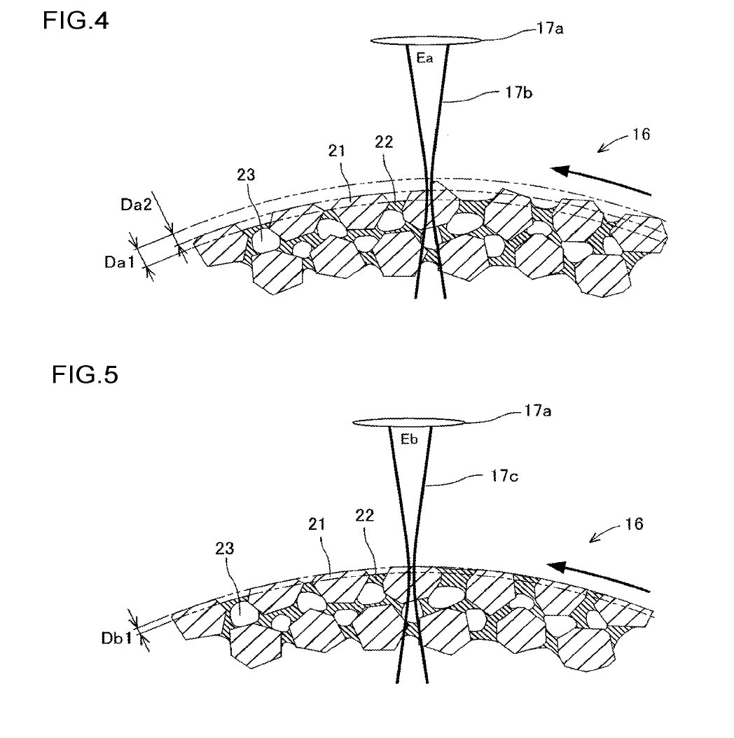

Truing of the grinding wheel 16 with laser light will be described with reference to FIG. 4. Truing is the process of shaping the surface of the grinding wheel 16 by processing the abrasive grains 21 and the binder 22 of the grinding wheel 16. In the present embodiment, dressing can be simultaneously performed by truing. Namely, by truing the grinding wheel 16, the surfaces of the abrasive grains 21 and the binder 22 can be shaped and the abrasive grains 21 can be made to protrude beyond the binder 22.

Laser light 17b for truing is emitted from the laser oscillator of the wheel truing device 17. The emitted laser light 17b is collected by a lens 17a onto the surface of the grinding wheel 16. The laser light 17b is thus focused on the surface of the grinding wheel 16. The laser light 17b is emitted in the normal direction to the surface of the grinding wheel 16 (the direction perpendicular to a tangent plane to the surface of the grinding wheel 16). The laser light 17b may be emitted in a direction tilted with respect to the normal direction to the surface of the grinding wheel 16 or may be emitted in the direction of a tangent to the surface of the grinding wheel 16.

The laser light 17b is ultrashort pulse laser light that can ablate (non-thermally process) the grinding wheel 16. For example, the laser light 17b is femtosecond laser light or picosecond laser light. Since truing is ablation processing, truing is less likely to thermally affect the grinding wheel 16. Accordingly, high processing accuracy can be achieved.

The energy density of the laser light 17b for truing is set to a higher value than the binder processing threshold E1 and the abrasive grain processing threshold E2. For example, the energy density of the laser light 17b is Ea in FIG. 3. Accordingly, the processing depth of the abrasive grains 21 is Da2 and the processing depth of the binder 22 containing TiC as the additive is Da1, as shown in FIG. 4. Since the processing depth Da1 of the binder 22 is greater than the processing depth Da2 of the abrasive grains 21, the shape of the topmost surface is formed by the abrasive grains 21, and the binder 22 is located deeper than the abrasive grains 21. Namely, dressing can be simultaneously performed by truing with the laser light 17b.

Dressing of the grinding wheel 16 with laser light will be described with reference to FIG. 5. Dressing herein refers to the process of processing only the binder 22 and not the abrasive grains 21 of the grinding wheel 16. The surface of the grinding wheel 16 is sharpened by dressing.

Laser light 17c for dressing is emitted from the laser oscillator of the wheel truing device 17. The emitted laser light 17c is collected by the lens 17a onto the surface of the grinding wheel 16. The laser light 17c is thus focused on the surface of the grinding wheel 16. The laser light 17c is emitted in the normal direction to the surface of the grinding wheel 16 (the direction perpendicular to a tangent plane to the surface of the grinding wheel 16). The laser light 17c may be emitted in a direction tilted with respect to the normal direction to the surface of the grinding wheel 16 or may be emitted in the direction of a tangent to the surface of the grinding wheel 16.

Like the laser light 17b for truing, the laser light 17c is ultrashort pulse laser light that can ablate (non-thermally process) the grinding wheel 16. For example, the laser light 17c is femtosecond laser light or picosecond laser light. Since dressing is ablation processing, dressing is less likely to thermally affect the grinding wheel 16. Accordingly, high processing accuracy can be achieved.

The energy density of the laser light 17c for dressing is set to a value higher than the binder processing threshold E1 and lower than the abrasive grain processing threshold E2. For example, the energy density of the laser light 17c is Eb in FIG. 3. Accordingly, the abrasive grains 21 are not processed and the processing depth of the binder 22 is Db1, as shown in FIG. 5. The abrasive grains 21 are thus exposed from the binder 22.

The grinding wheel 16 of the present embodiment includes the plurality of abrasive grains 21 and the binder 22 that holds the abrasive grains 21 together. The binder 22 contains an additive that has a higher extinction coefficient K than the abrasive grains 21 at a wavelength in the predetermined frequency band. The binder 22 is processed with laser light of a wavelength in the predetermined frequency band.

According to the grinding wheel 16, the binder 22 contains TiC as the additive which has a higher extinction coefficient κ than the abrasive grains 21 at a wavelength in the predetermined frequency band. The binder 22 therefore reliably absorbs laser light more than the abrasive grains 21 do. As a result, the binder 22 is reliably processed with the laser light. The grinding wheel 16 is therefore reliably trued or dressed with the laser light.

For the laser light 17b of the predetermined energy density Ea, the processing depth Da1 of the binder 22 is greater than the processing depth Da2 of the abrasive grains 21. The grinding wheel 16 is trued by processing the abrasive grains 21 and the binder 22 with the laser light 17b of the predetermined energy density Ea.

Since the binder 22 contains TiC as the additive, the processing depth Da1 of the binder 22 is greater than the processing depth Da2 of the abrasive grains 21 as described above. The abrasive grains 21 are therefore reliably exposed on the topmost surface as a result of truing. The binder 22 does not adhere to the abrasive grains 21 at the topmost surfaces of the abrasive grains 21. Dressing is thus simultaneously performed by truing.

The binder processing threshold E1 as the lowest energy density of laser light that can process the binder 22 is set to a value lower than the abrasive grain processing threshold E2 as the lowest energy density of laser light that can process the abrasive grains 21. The grinding wheel 16 is dressed by processing the binder 22 with the laser light 17c of the energy density Eb higher than the binder processing threshold E1 and lower than the abrasive grain processing threshold E2.

Since the binder 22 contains TiC as the additive, the binder processing threshold E1 is set to a value lower than the abrasive grain processing threshold E2 as described above. Accordingly, when the grinding wheel 16 is processed with the laser light 17c of the energy density Eb between the thresholds E1, E2, only the binder 22 is processed and the abrasive grains 21 are not processed. Dressing is therefore reliably performed.

For example, the main component of the binder 22 is the vitreous bond material. The extinction coefficient κ of the vitreous bond material is about the same as or lower than that of the abrasive grains 21. Accordingly, in the case where the binder 22 is made of only the vitreous bond material, it is difficult to process only the binder 22 and not to process the abrasive grains 21. As described above, however, since the binder 22 contains TiC as the additive which has a high extinction coefficient κ, the absorbance A_{λ} of the binder 22 can be made higher than that of the abrasive grains 21. Accordingly, even if the main component of the binder 22 is the vitreous bond material, truing or dressing can be reliably performed as the binder 22 contains TiC as the additive.

Advantageous effects of the grinding wheel 16 are described above. The grinding machine 10 including the grinding wheel 16 has similar advantageous effects. The grinding machine 10 of the present embodiment includes the grinding wheel 16 described above, and the wheel truing device 17 that emits the laser light 17b, 17c to process the grinding wheel 16 with the laser light 17b, 17c. The grinding machine 10 therefore has advantageous effects similar to those of the grinding wheel 16.

In the present embodiment, the grinding wheel 16 of the present invention may include, in addition to the grinding wheel 16 that grinds the workpiece W, a truer (also called a dresser) that trues and dresses the grinding wheel 16. Namely, a grinding wheel forming the truer (or the dresser) may be trued or dressed with laser light. The additive contained in the binder 22 may be any material other than TiC which has an extinction coefficient κ satisfying the above conditions.

What is claimed is:

1. A grinding wheel, comprising:
a plurality of abrasive grains; and
a binder mainly containing a bond material and holding the abrasive grains together; wherein
the binder contains an additive that has a higher extinction coefficient than the abrasive grains at a wavelength in a predetermined frequency band.

2. A grinding machine, comprising:
a wheel spindle stock on which the grinding wheel of claim 1 is mounted; and
a wheel truing device having a laser oscillator; wherein
the binder is processed by emitting laser light of the wavelength in the predetermined frequency band from the laser oscillator to the grinding wheel.

3. The grinding machine according to claim 2, wherein
an energy density of the laser light is set so that a processing depth of the binder with the laser light is greater than that of the abrasive grains with the laser light, and
the grinding wheel is trued as the abrasive grains and the binder are processed with the laser light of the set energy density.

4. The grinding machine according to claim 2, wherein
a binder processing threshold as a lowest energy density of the laser light which is set to process the binder is set to a value lower than an abrasive grain processing threshold as a lowest energy density of the laser light which is set to process the abrasive grains, and
the grinding wheel is dressed as the binder is processed with the laser light of an energy density higher than the binder processing threshold and lower than the abrasive grain processing threshold.
